(19) United States
(12) Patent Application Publication
(10) Pub. No.: US 2012/0037472 A1
(43) Pub. Date: Feb. 16, 2012

(54) APPARATUS FOR ACTUATING A POSTIVE SHIFTING ELEMENT SHIFTABLE AT LEAST BETWEEN TWO SHIFTING POSITIONS

(75) Inventors: Thomas Rosemeier, Meckenbeuren (DE); Christoph Pelchen, Tettnang (DE); Bernd-Robert Hohn, Munchen (DE)

(73) Assignee: ZF FRIEDRICHSHAFEN AG, Friedrichshafen (DE)

(21) Appl. No.: 13/264,780

(22) PCT Filed: Apr. 19, 2010
(86) PCT No.: PCT/EP2010/055102

§ 371 Date: Oct. 17, 2011

(30) Foreign Application Priority Data
Apr. 27, 2009 (DE) 10 2009 002 661.4

(51) Int. Cl. F16D 11/04

(52) U.S. Cl. 192/66.1

(57) ABSTRACT

An apparatus for actuating a form-locking shift element which can at least be shifter between two shifting positions, of a transmission device having a drive device and a drive converter device for converting rotational drive motion of the drive device into translatory motion of the form-locking shift element. Two transmission shafts are interconnected, by way of the shift element, in a rotationally fixed manner in one shifting position, and are decoupled from one another in another shifting position. The drive converter device comprises a first component having at least one control curve, and a second component that is operatively connected to the first component which, in the region of the control curve, are connected to a component of the form-locking shift element, which is connected to one of the transmission shafts in a rotationally fixed manner and is axially displaceable.

This application is a National Stage completion of PCT/EP2010/055102 filed Apr. 19, 2010, which claims priority from German patent application Ser. No. 10 2009 002 661.4 filed Apr. 27, 2009.

### FIELD OF THE INVENTION

The invention relates to an apparatus for actuating a form-locking shift element which can be shifted at least between three shifting positions.

### BACKGROUND OF THE INVENTION

In transmission devices known from practical application, rotating components such as transmission shafts or so-called idler gears are engaged into or disengaged from a flow of power of a transmission device via shift elements in a manner depending on the operating state, in order to attain various transmission ratios or transmission ratio ranges of a transmission device, and to switch therebetween.

In an embodiment of the shift elements as friction-locking shift elements, transmission ratios can be changed, preferably without interruption of tractive force, while maintaining a high level of driving comfort. Disengaged friction-locking shift elements are characterized by unwanted drag torques, however, which lower the efficiency of a transmission device.

Transmission devices provided with form-locking shift elements can be operated with greater efficiency since substantially lower drag torques occur in the region of form-locking shift elements, as is known. In contrast to transmission devices provided with friction-locking shift elements, transmission ratio changes involving form-locking shift elements can be carried out without interruption of tractive force only by employing further suitable measures which, however, increase the amount of construction space required in a transmission device and result in additional production costs.

Moreover, form-locking shift elements can be engaged or disengaged mainly only in the region of the synchronization point thereof, or near the synchronization point thereof, which is why structurally complex measures or complex control-related measures, via which form-locking shift elements can be synchronized in a targeted manner, are provided in practical applications to attain desired shift times.

Form-locking shift elements are often in the form of synchronizing mechanisms which, in order to synchronize the shift elements, include regions via which the differences in rotational speeds between the shift element halves can be compensated for within predefined times by friction engagement. However, such synchronizing mechanisms are subject to an unwanted high level of wear, which is disadvantageous, and are characterized by the need for a large amount of construction space.

On the control side, form-locking shift elements of vehicle transmission devices are guided, for instance, by corresponding guidance of engine rotational speed in the direction of the synchronized state thereof, and are subsequently disengaged or engaged.

In automated transmissions, form-locking shift elements are actuated via shift forks, for example, which can be driven electromechanically. Alternatively, form-locking connections between shafts of automated transmissions without synchronizing mechanisms or shift forks are activated or deactivated using pneumatically or hydraulically actuated, form-locking shift elements, for example. The functionality of such transmission devices can be ensured, however, only if sufficient sealing is provided in the region of supply lines and in the region of the shift elements themselves.

In order to operate vehicle transmission devices comprising form-locking shift elements with a desired level of spontaneity while maintaining a high level of driving comfort, appropriate shift times of form-locking shift elements must be attained with actuation that simultaneously takes driving comfort into account. To implement these requirements, an actuating speed must be varied depending on the operating state of a transmission device or the form-locking shift elements. The actuating speed of a form-locking shift element during operating states of a transmission device that are not critical to driving comfort can be designed to be faster than during operating states during which an actuating speed of a form-locking shift element that is too high impairs driving comfort to an undesired high extent.

A form-locking shift element is actuated with high actuating speeds during operating state progressions of a form-locking shift element during which the shift element is disengaged, to ensure short shift times and a high level of driving comfort. In contrast, a form-locking shift element is actuated only with low actuating speeds and high actuating forces during operating states in which the shift element is disengaged or engaged, in order to reliably attain a requested transmission ratio change in a transmission device without impairing driving comfort, and to overcome friction when the claws engage or disengage.

In the case of the above-described actuation of form-locking shift elements of transmission devices, which is known from practical application, high complexity of open-loop and closed-loop control is required to vary the actuating speed of form-locking shift elements, however, since the drive energy that is provided by a drive device that actuates a form-locking shift element must be changed depending on a current operating state of the form-locking shift element or the transmission device.

### SUMMARY OF THE INVENTION

The problem addressed by the present invention is therefore that of providing a device for the actuation of a form-locking shift element of a transmission device, by means of which actuation of the form-locking shift element can be varied to the desired extent in a simple, low-cost manner.

The device according to the invention for actuating a form-locking shift element of a transmission device, which can be shifted at least between two shifting positions, is designed with a drive device and a drive converter device for converting rotational drive motion of the drive device into translatory actuating motion of the form-locking shift element. By means of the shift element, two transmission shafts of the transmission device are interconnected in a rotationally fixed manner in one or two shifting positions, while the transmission shafts are decoupled from one another in a further shifting position of the shift element.

The drive converter device comprises a first component having at least one control curve and a second component operatively connected thereto, which are connected in the region of the control curve to a component of the form-locking shift element, which is connected to one of the transmission shafts in a rotationally fixed manner and is axially displaceable. A drive device-side, rotational relative motion between the first component and the second component of the drive converter device can be converted to translatory relative motion of the component of the shift element, wherein the control curve has a smaller absolute slope, at least in curve regions that are equivalent to the shifting positions of the form-locking shift element, in accordance with the translatory actuating motion of the shift element than in curve regions equivalent to the regions between the shifting positions of the form-locking shift element.

Due to the fact that the slopes of the control curve differ in sections, the translatory motion of the component of the form-locking shift element varies throughout the shift travel of the form-locking shift element while the drive power of the drive motor remains constant, thereby making it possible to cover shift travel ranges between the individual shifting positions of the form-locking shift element during which the transmission shafts are decoupled from each other, which is not critical to driving comfort, at a higher shift speed and without great forces, and making it possible to cover shift travel ranges during which a rotationally fixed connection between two transmission shafts is established or released, which are therefore shift ranges that are critical to driving comfort, at a lower shift speed and with a greater shift force, without the need to provide complex open-loop and closed-loop control in the region of the drive device.

This means that a varying shift speed of a form-locking shift element in the device according to the invention is obtained with high driving comfort and mainly using design means that can be manufactured at low cost, which are also characterized by a low construction space requirement and require only one small electric motor.

In an advantageous development of the device according to the invention, the absolute slope of the control curve in curve regions that are equivalent to a disengaged operating state of the form-locking shift element between the shifting position and a further shifting position, and between the further shifting position and an additional shifting position of the form-locking shift element, during which transmission shafts are interconnected in a rotationally fixed manner, is greater than that of the other curve regions of the control curve, thereby enabling shift times of transmission devices comprising the device according to the invention to be reduced compared to conventionally designed transmission devices in a simple, low-cost manner while maintaining a high level of driving comfort, or predefined shift times can be attained with less complexity and a high level of driving comfort.

In a further advantageous embodiment of the device according to the invention, the absolute slope of the control curve in curve regions that are equivalent to operating state progressions of the form-locking shift element during which a rotationally fixed connection between two of the transmission shafts is established or released in the region of the form-locking shift element via the component of the shift element, is greater than that of the curve regions that are equivalent to the shifting positions of the form-locking shift element. Therefore, the form-locking shift element can be held in the shifting positions of the form-locking shift element without application of an additional holding force, e.g. via self-inhibition, due to the smaller absolute slope, and a low shift speed combined with great shift force, i.e. great engagement or disengagement force, is attained due to the higher absolute slope in the curve regions during which a rotationally fixed connection between two of the transmission shafts is established or released in the region of the form-locking shift element via the component of the shift element.

In a structurally simple and low-cost embodiment of the device according to the invention, the component of the shift element is operatively connected to the first component and to the second component of the drive converter device in the region of at least one annular groove via at least one bolt element, wherein rotational disengagement between the component of the shift element and the first component and the second component of the drive converter device can be attained in the region between the bolt element and the annular groove of the component of the shift element.

In a simple embodiment of the device according to the invention, which can be manufactured at low cost, the second component is connected to the first component and to the component of the shift element in the region of at least one slot via the at least one bolt element.

During an engagement procedure of a form-locking shift element, in unfavorable operating states of the shift element, it is possible that the shift element cannot be engaged to the desired extent due to a tooth-on-tooth position while the claws of the form-locking shift element bear against one another in the region of the face surfaces thereof. A form-locking shift element cannot be engaged until the claws of the shift element halves to be interconnected rotate relative one another

To prevent the need to shut off the drive of the drive device during such situations, a further embodiment of the device according to the invention comprises a spring device between the drive device and the drive converter device for the intermediate storage of rotational drive energy of the drive device. The mechanical power delivered by the drive device is therefore stored for the interim in the region of the spring device. If the form-locking shift element can be moved into the engaged operating state thereof, e.g. via the release of the tooth-on-tooth position, or if it is possible to shift through in the region of the form-locking shift element, the potential energy stored in the region of the spring device supports the drive device as the component of the shift element is displaced further, thereby making it possible to attain the shortest shift time possible despite the phased delay.

In a structurally simple embodiment of the device according to the invention, which is characterized by simple assembly, the spring device is provided between a drive ring element, which can be driven by an electric motor of the drive device, and the second component of the drive converter device.

To prevent oscillations in the region of the spring device, the spring device in the advantageous development of the device according to the invention has, in the installed state, a preload to which potential energy can be stored in the region of the spring device when an actuating force is applied that is greater than a threshold force. Therefore, no potential energy is stored in the spring device in the region of the spring device during shift procedures during which shift-through can be carried out without delay in the region of the form-locking shift element, or during which a rotationally fixed connection between the transmission shafts is released without delay, or during non-delayed disengagement procedures of the form-locking shift element. This is attained by way of a spring device that has been preloaded accordingly, in the region of which potential energy is stored starting at a certain level of force.

A development of the device according to the invention which is particularly favorable in terms of construction space and is characterized by low manufacturing costs comprises a transmission device between a motor output shaft of the electric motor of the drive device, and the drive ring element, in the region of which a rotational motion of the electric motor is stepped down, and therefore only small amounts of drive torque need to be applied in the region of the electric motor to actuate the form-locking shift element.

In a development of the device according to the invention, which is favorable in terms of construction space, the components of the drive converter device and the form-locking shift element are disposed coaxially to one another and are preferably engaged, whereby the device requires minimal construction space particularly in the axial direction.

### BRIEF DESCRIPTION OF THE DRAWINGS

Further advantages and advantageous developments of the invention will become apparent from the claims and the embodiment, the principle of which is described with reference to the drawings.

They show:

FIG. 1 a highly schematicized depiction of a device for actuating a form-locking shift element of a transmission device, which can be shifted between three shifting positions;

FIG. 2 an exploded depiction of the device according to FIG. 1;

FIG. 3 a partial longitudinal sectional view of the device according to FIG. 1; and

FIG. 4 a partial view of a shape of a control curve of a first component of a drive converter device of the device according to FIG. 1.

### DETAILED DESCRIPTION OF THE PREFERRED EMBODIMENTS

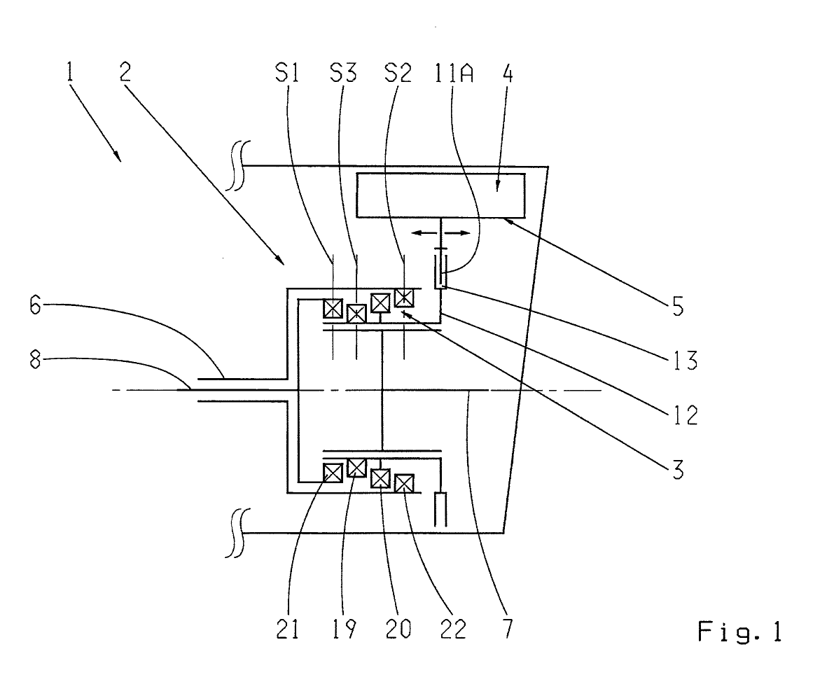

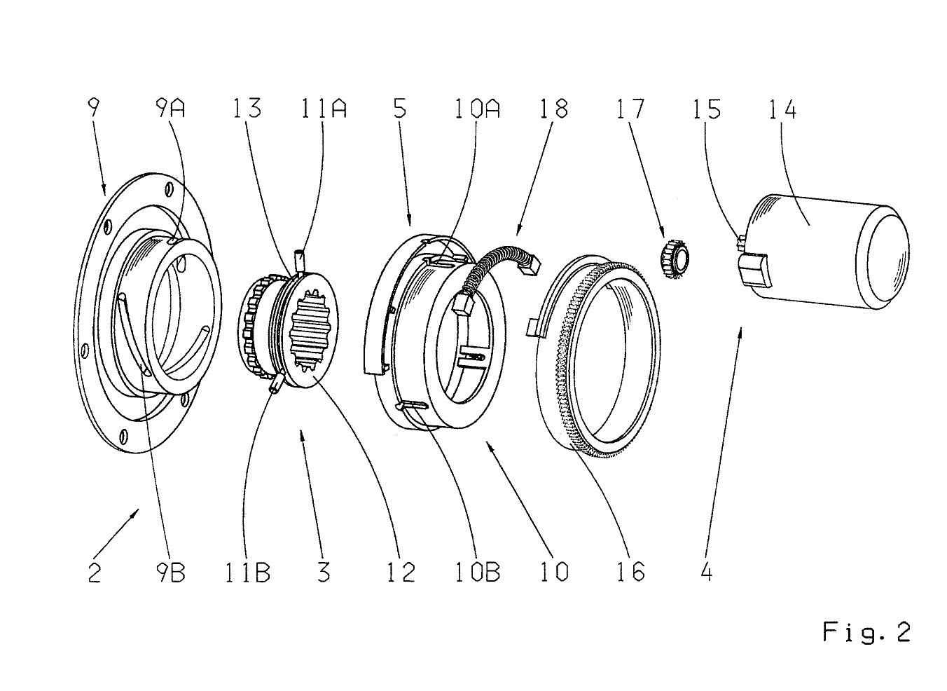

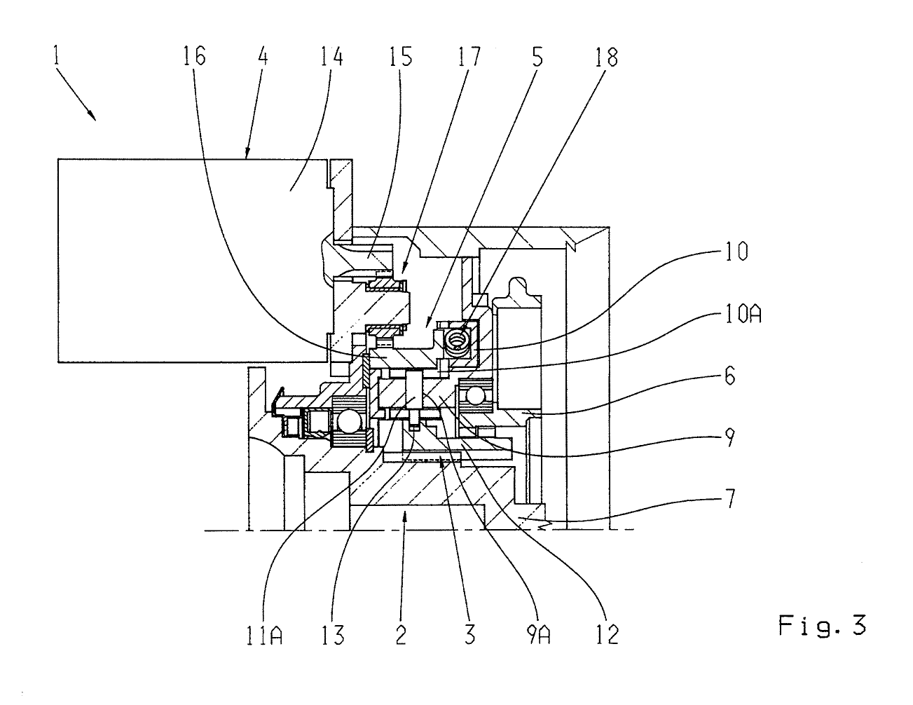

FIG. 1 shows a transmission device 1 comprising a device 2 for actuating a form-locking shift element which can be shifted between three shifting positions S1, S2 and S3, which comprises a drive device 4 and a drive converter device 5 shown in greater detail in FIG. 2 and FIG. 3 for converting rotational drive motion of the drive device 4 into translatory actuating motion of the form-locking shift element 3.

By means of the shift element 3, two transmission shafts 6 and 7, or 7 and 8 are interconnected in a rotationally fixed manner in a first shifting position S1 and in a second shifting position S2, while the transmission shafts 6 and 7, or 7 and 8 are decoupled from one another in a third shifting position S3 of the shift element 3.

The drive converter device 5 comprises a first component 9 having three control curves 9A and 9B distributed around the circumference of the first component 9, and a second component 10 which is operatively connected thereto, which are connected via bolt elements 11A and 11B in the region of the control curves 9A and 9B and the slots 10A, 10B of the second component 10 to a component 12 of the form-locking shift element, which is connected to the transmission shaft 7 in a rotationally fixed manner and is axially displaceable.

The two components 9 and 10 of the drive converter device 5 are operatively connected via bolt elements 11A and 11B which engage in an annular groove 13 of the component 12 of the form-locking shift element 3 in a manner such that different rotational speeds between the component 12 of the form-locking shift element 3 and the components 9 and 10 of the drive converter device 5 can be attained with low frictional losses, and drive device-side rotational relative motion between the first component 9 and the second component 10 is converted into translatory motion of the component 12 of the shift element 3.

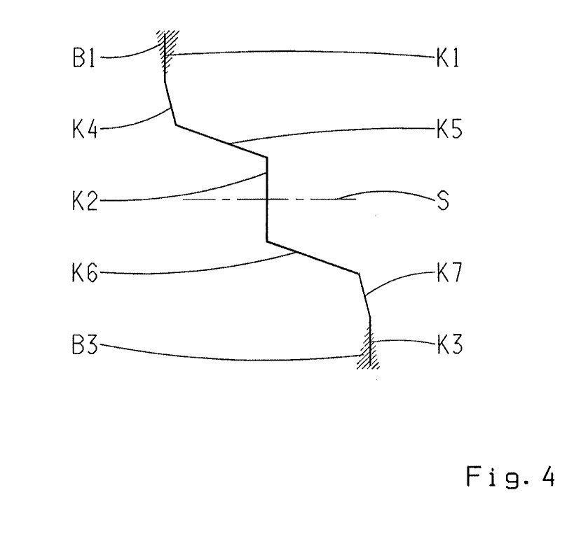

The control curves 9A and 9B of the first component 9 of the drive converter device 5 have a shape depicted in greater detail in FIG. 4, which is characterized by slopes which vary in sections of the curve in accordance with the translatory actuating motion of the component 12 of the shift element 3. The control curves 9A, 9B have a smaller absolute slope in curve regions K1, K2 and K3 which are equivalent to the shifting positions S1 to S3 of the form-locking shift element 3, than in curve regions K4 to K7 which are equivalent to the regions between the shifting positions S1 to S3 of the form-locking shift element 3.

In the present case, the drive device 4 is in the form of an electric motor 14, the rotational drive energy of which is transferred and stepped down via a transmission apparatus 17, which is in the form of a spur gear transmission in the present case, disposed between a motor output shaft 15 of the electric motor 14 of the drive device 4 and a drive ring element 16 of the drive converter device 5. It is therefore easily possible to dimension the electric motor 14 in regard to the torque capacity thereof in a manner that is favorable in terms of construction space and cost. Depending on the particular application, it is also possible to design the transmission apparatus as a worm gear pair or to use another suitable transmission.

Two different connections (modes) can be attained by utilizing the drive device 4 and the form-locking shift element 3 of the device 2. This takes place via the interconnection of the transmission shaft 7, which is an output shaft in the present case, with the transmission shaft 6 or the transmission shaft 8, which can be connected to one another or decoupled from one another using the form-locking shift element 3 which is designed as a form-locking claw clutch in the present case. The component 12 or the selector sleeve of the form-locking shift element 3 is disposed on the output shaft 7 in a rotationally fixed and axially movable manner, wherein the selector sleeve 12 is moved to the desired extent by the drive device 4 or the shift actuation to be described below in greater detail.

The components of the drive converter device 5 and the form-locking shift element 3 are disposed coaxially to one another and are engaged in the present case, whereby the device 2 requires minimal construction space in the axial direction, and the annular disk of the first component 9, which is relatively narrow in the axial direction, and in which the control curves 9A and 9B are disposed, can be utilized in entirety.

When the drive device 4 is active, the axial motion of the selector sleeve 12 results from the conversion of the rotational drive of the electric motor 14 into translatory drive motion carried out in the region of the switching device of the drive converter device 5. The conversion takes place via the correspondingly designed control curves 9A and 9B of the first component 9 of the drive converter device 5, which is a hollow shaft of the transmission device 1 secured to the housing. The control curves 9A and 9B extend along a helix at a slant relative to the circumferential direction of the first component 9, and so the bolt elements 11A and 11B also change their axial position when the bolt elements 11A and 11B rotate relative to the first component 9. The bolt elements 11A and 11B are displaced via the drive ring element 16 and the second component 10, which is operatively connected thereto, when the electric motor is driven accordingly.

Due to the above-described, varying slope of the control curves 11A and 11B in the curve sections K1 to K7, the axial actuating speed of the selector sleeve 13 varies along the shift travel thereof despite the constant rotational speed of the electric motor 14. For instance, the control curves 9A and 9B have a small absolute slope in the curve regions K1 and K3 to enable the selector sleeve 13 to attain self-locking in the shifting positions S1 and S2, in which the form-locking shift element 3 establishes a rotationally fixed connection between the transmission shafts 6 and 7, or 7 and 8, and to enable the selector sleeve 13 to be held without an additional application of holding force in the first or second shifting position S1 or S2 of the form-locking shift element 3.

It is possible to vary the slope of the control curves 9A and 9B in the curve regions K1 and K3 within the shaded regions B1 and B3 in order to hold the component 12 of the form-locking shift element 3 in the first shifting position S1 thereof or in the second shifting position S2 thereof without additional holding force. The boundaries of the slope ranges B1 and B3 represent a negative slope or an expansion, respectively, for holding claws of the form-locking shift element 3 in the particular shifting position S1 or S2, via an undercut, for example.

The curve regions K4 to K7 are designed with a greater absolute slope than exists in the curve regions K1 and K3, although with a smaller slope than in the curve regions K5 and K6, in order to attain a low axial actuating speed of the component 12 of the form-locking shift element 3 in the presence of high actuating force. The curve regions K4 and K7 are equivalent to operating state progressions of the form-locking shift element 3, during which claws 19, 20 of the form-locking shift element 3 are being engaged or disengaged with claws 21 of the transmission shaft 6, or with claws 22 of the transmission shaft 8. Via the selected slope of the control curves 9A and 9B, a high disengagement force can be provided in particular when a form-locking connection is released in the region of the form-locking shift element 3.

In the present case, the curve regions K5 and K6 represent so-called displacement ranges of the component 12 of the form-locking shift element 3 and are equivalent to operating states of the form-locking shift element 3 during which the form-locking shift element 3 is disengaged. Since the curve regions K5 and K6 are designed with a greater slope than the curve regions K1, K2, K3, K4 and K7, shifting can be carried out within a desired short shift time.

The curve region K2, which is equivalent to the third shifting position S3 of the form-locking shift element 3, is designed with a smaller absolute slope relative to the curve regions K5 and K6, to avoid having to stop the electric motor 14 using a drive motor of the form-locking shift element 3 during synchronization, for example. This results from the fact that the third shifting position S3 of the form-locking shift element 3 is the neutral position or the neutral operating state of the form-locking shift element 3, in which neither the transmission shaft 6 nor the transmission shaft 8 is connected to the transmission shaft 7, and which is maintained along the small slope of the curve region K2 and, therefore, by a low shift speed of the component 12 of the form-locking shift element 3 along a time interval that is long compared to the shift time intervals between the shifting positions S1 and S3, and S2 and S3.

The shape of the control curve 9A and of the control curve 9B depicted in FIG. 4 has a qualitatively analogous shape relative to a bisecting line S for each shift side of the form-locking shift element 3, although a quantitative adaptation of the curve shape of the control curves 9A and 9B to various claw geometries of the form-locking shift element 3 and the transmission shaft 6 and 8 is possible.

The rotational drive of the electric motor 14 is transferred by the drive ring element 16 to the second component 10 of the drive converter device 5 via a preloaded spring device 18, wherein rotational relative motion between the drive ring element 16 and the second component 10 that is greater, starting at an actuating force, than a predefined threshold value brings about a change in the potential energy of the spring device 18. Due to the preload of the spring device 18, an actuating force that exceeds the threshold force is required to rotate the second component 10 relative to the drive ring element 16, and is stored in the region of the spring device 18.

If a shift-through initially cannot be completed, for instance, in the region of the form-locking shift element 3 due to a tooth-on-tooth position, or due to the claws 19 or 20 of the form-locking shift element colliding with the claws 21 or 22 of the transmission shaft 6 or the transmission shaft 8, the rotational drive energy introduced by the electric motor 14 into the system is stored for the interim in the region of the spring device 18. If the blockade in the region of the form-locking shift element 3 preventing the shift-through in the region of the form-locking shift element 3 is released, for example, via a rotational speed difference between the shift element halves of the form-locking shift element 3 that is required for the shift-through, the potential energy stored in the region of the spring device 18 supports the electric motor 14 in the acceleration of the selector sleeve 12, whereby the shift time of the form-locking shift element 3 is kept short.

Moreover, oscillations between the second component 10 and the drive ring element 16, which impair the functionality of the device 2, are prevented when shifting takes place unobstructed via the preload of the spring device 18 and the friction relative to the second component 10 and the adjusting collar of the drive converter device 5 and the spring device 18.

The device according to the invention is basically characterized in that minimal axial construction space is required, and a form-locking shift element can be shifted within desired short shift times using a small electric motor. The device according to the invention is also characterized by a small number of parts, and can therefore be manufactured at low cost. Moreover, complex test stand evaluations and adjustments of a transmission device comprising the device can be replaced by lower cost simulations, during which the operating parameters and component parameters are fine-tuned.

### REFERENCE CHARACTERS

1 transmission device
2 device
3 form-locking shift element
4 drive device
5 drive converter device
6 to 8 transmission shaft
9 first component
9A, 9B control curve
10 second component
10A, 10B slot
11A, 11B bolt element
12 component of the form-locking shift element
13 annular groove of the form-locking component
14 electric motor
15 motor output shaft
16 drive ring element
17 transmission apparatus
18 spring device
19, 20, 21, 22 claws
B1, B3 slope range
K1 to K7 curve range of the control curve
S bisecting line
S1 to S3 shifting position of the form-locking shift element

1-12. (canceled)

13. An actuating device (1) for actuating a form-locking shift element (3), of a transmission device (1), which is shiftable at least between two shifting positions (S1, S2, S3), the actuating device (1) having a drive device (4) and a drive converter device (5) for converting rotational drive motion of the drive device (4) into translatory actuating motion of the form-locking shift element (3),
wherein, via the shift element (3), two transmission shafts (6, 7 or 7, 8) being interconnected in a rotationally fixed manner in either one or two shifting positions (S1 and S2), and the two transmission shafts (6, 7 or 7, 8) being decoupled from one another in a further shifting position (S3) of the shift element (3),
the drive converter device (5) comprising a first component (9) having at least one control curve (9A, 9B) and a second component (10) operatively connected thereto which, in a region of the control curve (9A, 9B), being connected to a component (12) of the form-locking shift element (3), which is connected to one of the two transmission shafts (7) in a rotationally fixed and axially displaceable manner, and a drive device-side, rotational relative motion, between the first component (9) and the second component (10), being converted into translatory motion of the component (12) of the form-locking shift element (3); and
the control curve (9A, 9B) having a smaller absolute slope, at least in first curve regions (K1, K2, K3) that are equivalent to the shifting positions (S1, S2, S3) of the form-locking shift element (3), in accordance with the translatory actuating motion of the component (12) of the form-locking shift element (3) than second and third curve regions (K4, K5, K6, K7) that are equivalent to the regions between the shifting positions (51, S2, S3) of the form-locking shift element (3).

14. The device according to claim 13, wherein the absolute slope of the control curve (9A, 9B) in the second curve regions (K5, K6), which are equivalent to a disengaged operating state of the form-locking shift element (3) between a first shifting position (S1) and the further shifting position (S3) and between the further shifting position (S3) and an additional shifting position (S2) during which the transmission shafts (7, 8) are interconnected in a rotationally fixed manner, is greater than that of the first and the third curve regions (K1 to K4, K7) of the control curve (9A, 9B).

15. The device according to claim 13, wherein the absolute slope of the control curve (9A, 9B) in the third curve regions (K4, K7), which are equivalent to operating state progressions of the form-locking shift element (3) during which a rotationally fixed connection between two of the transmission shafts (6, 7, 8) is either established or released in the region of the form-locking shift element (3) via the component (12) of the form-locking shift element (3), is greater than that of the first curve regions (K1 to K3) which are equivalent to the shifting positions (S1, S2, S3) of the form-locking shift element (3).

16. The device according to claim 13, wherein the component (12) of the form-locking shift element (3) is operatively connected, via at least one bolt element (11A, 11B), to the first component (9) and to the second component (10) in a region of an annular groove (13).

17. The device according to claim 16, wherein the second component (10) is connected, via the at least one bolt element (11A, 11B), to the first component (9) and to the component (12) of the form-locking shift element (3) in a region of at least one slot (10A, 10B).

18. The device according to claim 13, wherein a spring device (18), for intermediate storage of rotational drive energy of the drive device (4), is disposed between the drive device (4) and the drive converter device (5).

19. The device according to claim 18, wherein the spring device (18) is provided between a drive ring element (16), which is driven by an electric motor (14) of the drive device (4), and the second component (10).

20. The device according to claim 18, wherein the spring device (18), in an installed state, is preloaded in which potential energy is stored in a region of the spring device (18) when an actuating force, that is greater than a threshold force, is applied.

21. The device according to claim 19, wherein a transmission apparatus (17) is provided between a motor output shaft (15) of the electric motor (14) of the drive device (4) and the drive ring element (16), in a region of which rotational motion of the electric motor (14) is stepped down.

22. The device according to claim 21, wherein the transmission apparatus (17) is a spur gear transmission.

23. The device according to claim 21, wherein the transmission apparatus comprises a worm gear pair.

24. The device according to claim 13, wherein the components of the drive converter device (5) and the form-locking shift element (3) are disposed coaxially with respect to one another.

25. An actuating device (2) for actuating a form-locking shift element (3), which is shiftable at least between first and second shifting positions (S1, S2, S3), of a transmission device (1), the actuating device comprising:
a drive device (4) and a drive converter device (5), the drive device (4) driving the form-locking shift element (3) via the drive converter device (5), and the drive converter device (5) converting rotational drive from the drive device (4) into axial drive for axially driving the form-locking shift element (3);
when the form-locking shift element (3) is in the second shift position (S2), a first transmission shaft (6) being connected in a rotationally fixed manner, via the form-locking shift element (3), to a second transmission shaft (7); when the form-locking shift element (3) is in the first shift position (S1), a third transmission shaft (8) being connected in a rotationally fixed manner, via the form-locking shift element (3), to the second transmission shaft (7); and when the form-locking shift element (3) is in a third shift position (S3), the second transmission shaft (7) being decoupled from both of the first and the third transmission shafts (6, 8);
the drive converter device (5) comprising a cylindrical first component (9) having at least one axially extending helical channel (9A, 9B) and a second component (10) being operatively connected to the first component (9);
the form-locking shift element (3) comprising a third component (12) being connected in a rotationally fixed and axially slidable manner to the second transmission shaft (7) such that rotation between the first component (9) and the second component (10) is converted into axial motion of the third component (12);
the helical channel (9A, 9B) having first, second, third, fourth, fifth, sixth, and seventh regions (K1, K2, K3, K4, K5, K6, K7) that extend along an axis of the first component (9), the first, the second and the third regions (K1, K2, K3) of the helical channel (9A, 9B) correspond respectively to the first, the third and the second shift positions (S1, S3, S2) of the form-locking shift element (3) and have a smaller absolute slope than the fourth, the fifth, the sixth, and the seventh regions (K4, K5, K6, K7) of the helical channel (9A, 9B), the fourth and the fifth regions (K4, K5) are axially adjacent and located between the first and the third regions (K1, K2) and correspond to positions between the first and the third shift positions (S1, S3), the sixth and the seventh regions (K6, K7) are axially adjacent and located between the third and the second regions (K3, K2) and correspond to positions between the third and the second shift positions (S3, S2).
